(19) United States
(12) Patent Application Publication
(10) Pub. No.: US 2007/0160435 A1
(43) Pub. Date: Jul. 12, 2007

(54) Hole cutter having detachable hole-sawing blade

(76) Inventor: Walley Chao, Taichung (TW)

Correspondence Address: BACON & THOMAS, PLLC, 625 SLATERS LANE, FOURTH FLOOR, ALEXANDRIA, VA, 22314, US

(21) Appl. No.: 11/401,325

(22) Filed: Apr. 11, 2006

(30) Foreign Application Priority Data
Jan. 11, 2006 (TW) 95200667

(51) Int. Cl. B23B 39/00; B23B 51/04

(52) U.S. Cl. 408/102; 408/204

(57) ABSTRACT

A hole cutter includes a shaft connectable to a rotary driving tool, a ball mounted in a locating hole of the shaft, a detachable hole-sawing blade assembly detachably inserted into a bottom open chamber of the shaft, a socket supported on a spring member provided at the shaft to force the ball to lock the detachable hole-sawing blade assembly, and a drill bit inserted through the detachable hole-sawing blade assembly into the inside of the shaft and locked by a screw rod.

### BACKGROUND OF THE INVENTION

1. Field of the Invention

The present invention relates to a hole cutter for sawing a circular hole and more particularly, to a hole cutter having a hold-sawing blade that is detachable and can be replaced quickly.

2. Description of the Related Art

A conventional hole cutter is known using two knife blades to cut the workpiece through a rotary motion. Taiwan patent publication No. M244141 discloses a similar design. According to this design, the hole cutter comprises a holder base, a drill bit, a rod scale, two sliding blocks, two knife blades, a dust cap, and a quick-release connector. The quick-release connector connects the hole cutter to a rotary driving tool so that the two knife blades are rotatable with the rotary driving tool to cut the workpiece. However, this design of hole cutter is still not satisfactory in function. When one knife blade is damaged or starts to wear, the whole assembly must be disassembled so that the knife blade can be detached for a replacement or repair. Further, because the knife blades are slidably mounted on the rod scale. When cutting a different size of workpiece, it takes a lot of time to adjust the position of the knife blades.

### SUMMARY OF THE INVENTION

The present invention has been accomplished under the circumstances in view. It is one object of the present invention to provide a hole cutter, which allows quickly replacement of the cylindrical hole-sawing blade.

It is another object of the present invention to provide a hole cutter, which uses a spring-supported socket with a tapered inside wall to control the positioning of a ball and to further force the ball to lock a hole-sawing blade assembly positively.

To achieve these objects of the present invention, the hole cutter comprises a shaft, a ball, a socket, a spring member, a hole-sawing assembly and a drill bit. The haft has a bottom open chamber with a polygonal cross section in a bottom side thereof, an inside hole axially upwardly extending from the bottom open chamber toward a top side thereof, and a locating hole extending transversely and communicating with the bottom open chamber. The ball is movably mounted in the locating hole of the shaft. The socket is capped on the shaft and movable axially relative to the shaft. The socket has a tapered inside wall contacted with the ball and movable with the socket relative to the shaft between a first position where the ball doesn't project into the bottom open chamber and a second position where the ball is forced by the tapered inside wall to project partially into the bottom open chamber. The spring member is sleeved onto the shaft and stopped between a part of the shaft and a part of the socket to support the socket in the second position. The hole-sawing blade assembly has a connector detachably fitted into the bottom open chamber of the shaft, and a cylindrical hole-sawing blade detachably connected to the connector. The connector has a polygonal cross section that fits the polygonal cross section of the bottom open chamber of the shaft, an axial center through hole, and at least one locating recess for receiving the ball to lock the connector to the shaft. The drill bit has a shank inserted through the axial center through hole of the connector and fitted into the inside hole of the shaft.

### BRIEF DESCRIPTION OF THE DRAWINGS

FIG. 1 is a perspective view of a hole cutter according to a preferred embodiment of the present invention.

FIG. 2 is an exploded view of the hole cutter according to the preferred embodiment of the present invention.

FIG. 3 is a sectional view showing the hole cutter assembled.

FIG. 4 is a schematic view showing the hole-sawing blade assembly detached from the shaft according to the preferred embodiment of the present invention.

### DETAILED DESCRIPTION OF THE INVENTION

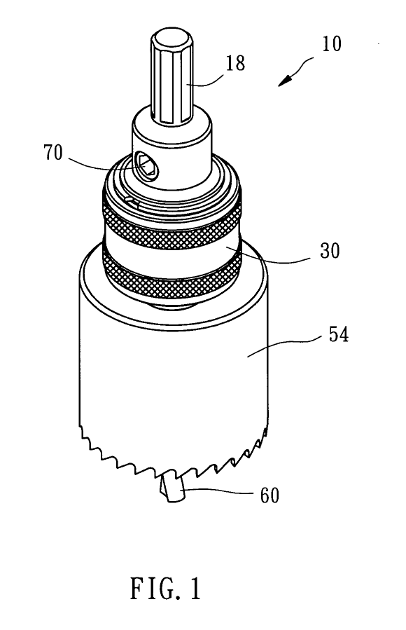

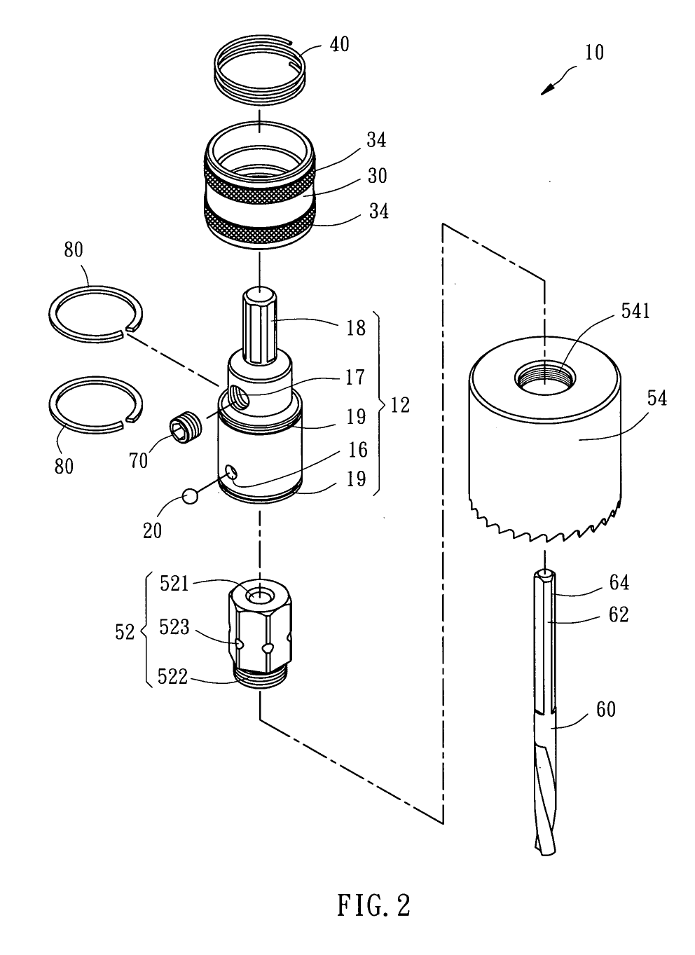

Referring to FIGS. 1-4, a hole cutter 10 in accordance with a preferred embodiment of the present invention is shown comprising a shaft 12, a steel ball 20, a socket 30, a spring member 40, a hole-sawing blade assembly 50, a drill bit 60, a screw rod 70, and retaining members 80.

The shaft 12 is a stepped cylindrical member having a bottom open chamber 14, which has a hexagonal cross section, an inside hole 15 axially extending from a bottom of the bottom open chamber 14 towards a top side of the shaft, a locating hole 16 transversely extending from one side of the bottom open chamber 14 to the outer periphery of the shaft 12, a screw hole 17 transversely extending from one side of the inside hole 15 to the periphery of the shaft 12, a top coupling portion 18 axially disposed at the top side remote from the bottom open chamber 14 and connectable to a rotary driving tool (not shown), and two locating grooves 19 extending around the outer periphery of the shaft 12 at different elevations for the positioning of the retaining members 80.

The steel ball 20 is movably mounted in the locating hole 16 of the shaft 12 and can be forced to project partially into the bottom open chamber 14.

The socket 30 is axially moveably capped on the shaft 12. The socket 30 has a tapered inside wall 32 sloping in one direction and disposed in contact with the steel ball 20 to hold the steel ball 20 in the locating hole 16, and two embossed surface portions 34 respectively formed on an outer periphery near the two distal ends thereof for the gasping of the user's fingers so that the user can positively move the socket 30 relative to the shaft 12 between a first position where the steel ball 20 doesn't project into the bottom open chamber 14 as shown in FIG. 4 and a second position where the steel ball 20 is forced by the tapered inside wall 32 to project partially into the bottom open chamber 14.

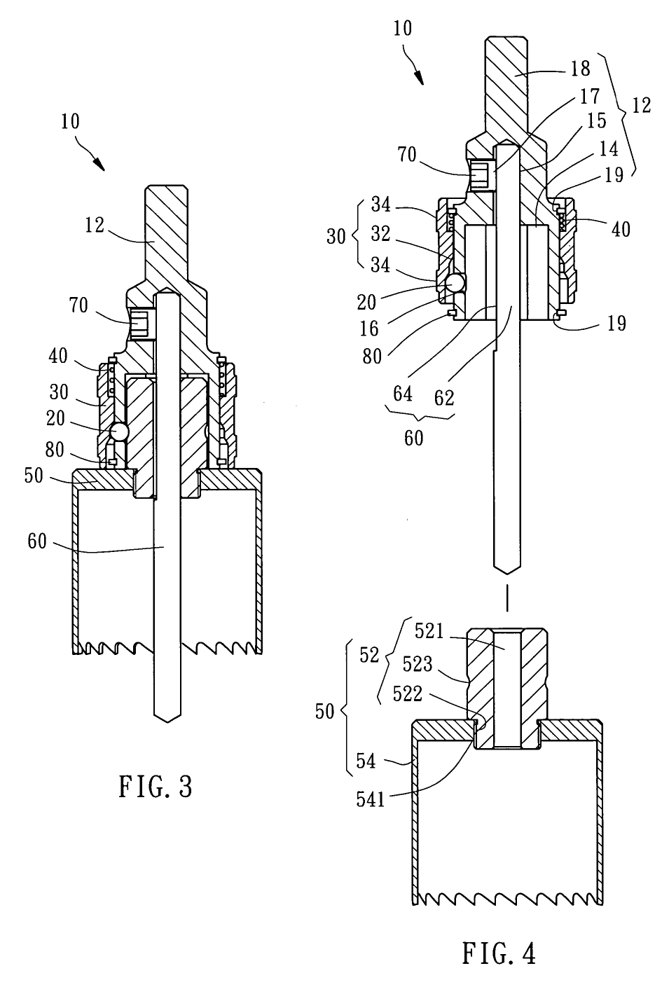

The spring member 40 is sleeved onto the shaft 12 and stopped between one retaining member 80 and the socket 30 for returning the socket 30 after each movement of the socket 30 relative to the shaft 12, i.e. the spring member 40 supports the socket 30 in the second position as shown in FIG. 3 in a normal situation.

The hole-sawing blade assembly 50 comprises a connector 52 and a cylindrical hole-sawing blade 54. The connector 52 is mounted in the bottom open chamber 14 of the shaft 12, having a hexagonal cross section that fits the hexagonal cross section of the bottom open chamber 14, an axial center through hole 521, a bottom connection neck 522, which is a threaded neck, and a locating recess 523 at each of the six angles of the hexagonal outside wall. The cylindrical hole-sawing blade 54 has a top connection portion 541, which is a hole with a female thread threaded onto the threaded bottom connection neck 522 of the connector 52. When the hole cutter 10 is rotated, the female thread of the top connection portion 541 fasten tight the cylindrical hole-sawing blade 54.

The drill bit 60 has a shank 62 with positioning planes 64. The shank 62 is inserted through the axial center through hole 521 of the connector 52 and fitted into the inside hole 15 of the shaft 12 for positioning on the center of the designed hole to be sawed.

The screw rod 70 is threaded into the screw hole 17 of the shaft 12 and partially projects into the inside hole 15 of the shaft 12 so that an end of the screw rod 70 can be stopped against the one plane 64 of the shank 62 to tighten up the drill bit 60.

The retaining members 80 are C-shaped retainers respectively fastened to the locating grooves 19 of the shaft 12.

When in use, as shown in FIGS. 3 and 4, the selected size of cylindrical hole-sawing blade 54 is fastened to the connector 52, and then the socket 30 is pushed upwards with the hand to release the pressure from the steel ball 20 for enabling the steel ball 20 to move along the tapered inside wall 32 in direction away from the bottom open chamber 14 of the shaft 12, and then the connector 52 is fitted into the bottom open chamber 14 of the shaft 12. When released the hand from the socket 30, the spring member 40 immediately returns the socket 30 to force the tapered inside wall 32 against the steel ball 20 in the reversed direction, thereby forcing the steel ball 20 into engagement with one locating recess 523 of the connector 52, and therefore the connector 52 is locked to the shaft 12.

As indicated above, the invention provides a hole cutter that has features as follows.

1. The hole-sawing blade assembly of the hole cutter can easily and quickly be coupled to the shaft and then positively locked by the steel ball that is forced by the socket into engagement with one locating recess at one of the six angles of the outside wall of the connector of the hole-sawing blade assembly.

2. The socket has a tapered inside wall sloping in one direction for controlling the positioning of the steel ball to force the steel ball into positive engagement with the connector of the hole-sawing blade assembly.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A hole cutter comprising:
a shaft having a bottom open chamber in a bottom side thereof, an inside hole axially upwardly extending from said bottom open chamber toward a top side thereof, and a locating hole extending transversely and communicating with said bottom open chamber, said bottom open chamber having a polygonal cross section;
a ball movably mounted in said locating hole of said shaft;
a socket capped on said shaft and movable axially relative to said shaft, said socket having a tapered inside wall contacted with said ball and movable with said socket relative to said shaft between a first position where said ball doesn't project into said bottom open chamber and a second position where said ball is forced by said tapered inside wall to project partially into said bottom open chamber;
a spring member sleeved onto said shaft for supporting said socket in said second position;
a hole-sawing blade assembly having a connector detachably fitted into said bottom open chamber of said shaft, and a cylindrical hole-sawing blade connected to said connector, said connector having a polygonal cross section that fits the polygonal cross section of said bottom open chamber of said shaft, an axial center through hole, and at least one locating recess at an outside wall thereof for receiving said ball to lock said connector to said shaft; and
a drill bit having a shank inserted through the axial center through hole of said connector and fitted into the inside hole of said shaft.

2. The hole cutter as claimed in claim 1, wherein said shaft further has a screw hole extending transversely and communicating with said inside hole, and a screw rod threaded into said screw hole and stopped against said shank of said drill bit to lock said drill bit to said shaft.

3. The hole cutter as claimed in claim 1, wherein said shaft has a top coupling portion connectable to a rotary driving tool.

4. The hole cutter as claimed in claim 1, wherein said shaft further has a locating groove extending around a periphery thereof, and a retaining member fastened to said locating groove and stopped against one end of said spring member.

5. The hole cutter as claimed in claim 1, wherein said connector has a bottom connection neck, said cylindrical hole-sawing blade has a top connection portion detachably connectable to said bottom connection neck of said connector.

6. The hole cutter as claimed in claim 1, wherein said socket has two embossed portions extending around a periphery thereof at two distal ends thereof.
